(19) United States
(12) Patent Application Publication
(10) Pub. No.: US 2025/0241413 A1
(43) Pub. Date: Jul. 31, 2025

(54) DEVICE AND METHOD FOR MEASURING FEET AND RECOMMENDING WELL-FITTING FOOTWEAR

(71) Applicant: MEASUREDFIT TECHNOLOGIES LIMITED, Hayes (GB)

(72) Inventor: Osatohanmwen Bill AGHATISE, Hayes (GB)

(21) Appl. No.: 18/848,631

(22) PCT Filed: Mar. 20, 2023
(86) PCT No.: PCT/GB2023/050669

§ 371 Date: Sep. 19, 2024

(30) Foreign Application Priority Data
Mar. 21, 2022 (GB) 2203926.7

(51) Int. Cl. A43D 1/02; G01B 3/1003

(52) U.S. Cl. CPC A43D 1/02; G01B 3/1003

(57) ABSTRACT

A device for measuring a human foot, the device comprising: a first member for abutting against a first portion of the foot; a second member for abutting against a second portion of the foot, the second member opposing the first member; and a measuring tape, wherein a proximal end of the measuring tape is coupled to the first member and a distal end of the measuring tape is coupled to the second member, the measuring tape being extendable from and retractable into the first member; wherein the measuring tape comprises measurement indicia along at least part of the length of the tape; and wherein the first member comprises a window through which a portion of the measurement indicia, representative of the extent of extension of the measuring tape from the first member, is visible in use. A method of using such a device, and for obtaining correctly-fitting footwear as a result, are also provided.

### FIELD OF THE INVENTION

This invention relates to a device for measuring feet and to an associated method of using such a device, and in turn to recommending well-fitting footwear. The device and method are particularly suitable for, but by no means limited to, performing measurements of human feet.

### BACKGROUND TO THE INVENTION

Footwear, such as shoes, boots and the like, has traditionally been sized in semi-standardised formats (such as “UK men's/women's sizes”, “US men's/women's sizes”, “EU men's/women's sizes”, etc.) to ensure that the wearer can obtain footwear appropriate to the size of their feet.

In this regard, the wearer's “shoe size” is typically obtained by measuring, e.g. with a tape measure or a ruled template, the longest part of the wearer's foot (which would usually be taken from the wearer's heel to their biggest toe) and comparing the measured length to one of several sizing scales to derive the wearer's shoe size. For instance, if the longest part of a UK male wearer's foot was measured as 254 mm, this would correspond to a UK men's size 7 (which itself corresponds an EU men's size 41).

A further measurement may be taken, e.g. with a tape measure, to determine the width of the wearer's foot. For example, in the UK, a letter system from E to H is used to denote widths of various feet within a given range, with E denoting a narrow fitting, F denoting a standard fitting, G denoting a wide fitting, and H denoting an extra-wide fitting.

However, because sizing systems used around the world are not well standardised, and there is also a degree of inconsistency between different footwear manufacturers' manufacturing equipment (e.g. the foot-shaped “lasts” on which footwear is made), one particular manufacturer who marks their footwear as size X may actually produce footwear which is larger or smaller than the “same” size of footwear marked as size X by another manufacturer. Therefore, when obtaining footwear, a customer may obtain footwear which is inappropriate for the actual size of their foot.

There is therefore a need for apparatus that addresses at least some of the above problems, to enable the accurate measurement of a user's foot, and, in turn, to provide a system whereby footwear can be provided that correctly fits the measured foot.

### SUMMARY OF THE INVENTION

The present invention is defined in the appended independent claims, whereas optional features are set out in the appended dependent claims.

According to a first aspect of the invention there is provided a device for measuring a human foot, the device comprising: a first member for abutting against a first portion (e.g. toe end) of the foot; a second member for abutting against a second portion (e.g. heel) of the foot, the second member opposing the first member; and a measuring tape, wherein a proximal end of the measuring tape is coupled to the first member and a distal end of the measuring tape is coupled to the second member, the measuring tape being extendable from and retractable into the first member; wherein the measuring tape comprises measurement indicia along at least part of the length of the tape; and wherein the first member comprises a window through which a portion of the measurement indicia, representative of the extent of extension of the measuring tape from the first member (e.g. representative of the length of the foot), is visible in use.

By virtue of the features of such a device, including the measurement indicia and the window in which a portion of the measurement indicia appear, accurate measurement of a user's foot may be obtained.

The first member may further comprise a spring-biased spool, onto which the measuring tape is retractable, and from which the measuring tape is extendable.

The first member may further comprise an internal guide structure, by means of which the measuring tape from the spool is arranged to pass across the window, within the first member, before coming out of the first member (e.g. through an exit aperture or slot). By virtue of such a guide structure, the said portion of the measurement indicia may be reliably and consistently presented through the window.

To enable the substantially simultaneous measurement of the width of the foot as well as the length, in presently-preferred embodiments the measuring tape is a first measuring tape, and the device further comprises: a third member for abutting against a third portion (e.g. one side) of the foot; a fourth member for abutting against a fourth portion (e.g. the other side) of the foot, the fourth member opposing the third member; a second measuring tape, wherein a proximal end of the second measuring tape is coupled to the third member and a distal end of the second measuring tape is extendable away from the third member, the second measuring tape being extendable from and retractable into the third member; and a third measuring tape, wherein a proximal end of the third measuring tape is coupled to the fourth member and a distal end of the third measuring tape is extendable away from the fourth member, the third measuring tape being extendable from and retractable into the fourth member; wherein the distal end of the third measuring tape is coupled to the distal end of the second measuring tape; wherein each of the second and third measuring tapes comprises measurement indicia along at least part of the length of the respective tape; and wherein the third member comprises a second window and the fourth member comprises a third window through which a respective portion of the measurement indicia of the respective second and third measuring tapes, representative of the extent of extension of the second and third measuring tapes, are visible in use.

The distal end of the third measuring tape may be coupled to the distal end of the second measuring tape by means of a sleeve through which the first measuring tape slidably passes. This enables the third and fourth members and the respective second and third measuring tapes to be slidably adjusted along the first measuring tape, between the first and second members, thereby enabling the widths of differently-shaped feet to be readily measured.

Each of the third and fourth members may further comprise a respective spring-biased spool, onto which the respective measuring tape is retractable, and from which the respective measuring tape is extendable.

Each of the third and fourth members may further comprise a respective internal guide structure, by means of which the respective measuring tape from the respective spool is arranged to pass across the respective window, within the respective member, before coming out of the respective member.

Alternatively, the device may comprise: a third member for abutting against a third portion of the foot; a fourth member for abutting against a fourth portion of the foot, the fourth member opposing the third member; and a second measuring tape, wherein a proximal end of the second measuring tape is coupled to the third member and a distal end of the second measuring tape is coupled to the fourth member, the second measuring tape being extendable from and retractable into the third member; wherein the second measuring tape comprises measurement indicia along at least part of the length of the tape; and wherein the third member comprises a window through which a portion of the measurement indicia, representative of the extent of extension of the second measuring tape from the third member, is visible in use.

Preferably the third and fourth members are generally perpendicular to an axis of the first measuring tape, and are mutually movable along the axis of the first measuring tape.

Optionally the third member and the fourth member may be mutually couplable to one another at a fifth portion of the foot, for measuring the girth (around the top) of the foot. Thus, advantageously, the third and fourth members may be used to obtain two separate measurements, namely a width measurement (by moving the third and fourth members laterally in the horizontal plane of the device) and a girth measurement (by moving the third and fourth members out of the horizontal plane of the device and coupling them together around the top of the foot).

Optionally the third member and the fourth member may each comprise magnets for mutual coupling between the third and fourth members.

Optionally the first member and the second member may comprise magnets for respectively coupling to the third member and the fourth member.

Optionally at least one of the members comprises a lanyard or handle.

In certain embodiment at least one window of the device may be provided with an identifying marker around or adjacent to at least part of the window, by means of which the window (and thus the member on which it is provided) can be uniquely identified.

Advantageously the members may be configured to tessellate into a closed configuration when the respective measuring tapes are fully retracted, thereby enabling the device to be stored or carried compactly.

Optionally the first member and/or the second member may further comprise an inwardly-extending base part on which the user places a respective portion of their foot in use. Advantageously, the or each inwardly-extending base part may also be arranged to align and support the third and fourth members when the device is in the closed configuration.

Optionally the second member may further comprise a further measuring strap (e.g. for obtaining a so-called “long heel” measurement). Moreover, the further measuring strap may be usable to wrap around the members to secure the device in the closed configuration.

According to presently-preferred embodiments, the measurement indicia comprises a two-dimensional barcode (patterned binary code) extending in a first direction along at least part of the length of the respective measuring tape, and in a second direction across at least part of the width of the measuring tape; wherein the two-dimensional barcode comprises a plurality of successive rows of pixels neighbouring each other in the first direction; and wherein each row of pixels extends in the second direction and uniquely encodes a respective measurement value. Advantageously, such a barcode is able to provide a high degree of precision in respect of the measurements that are made (i.e. accurate measurements, in small increments), removes the possibility of human error when reading such measurements (as a result of being machine-readable rather than human-readable), and permits digital integration with a system for providing correctly-sized footwear.

Each row of pixels may comprise the respective measurement value encoded into a binary measurement bit string, wherein, in each measurement bit string, pixels of a first colour (e.g. black) denote bits of ‘1’, and pixels of a second colour (e.g. white) denote bits of ‘0’.

The measurement bit string may comprise any suitable number of binary digits or bits. For example, it may comprise nine binary digits, although other numbers are also possible.

In addition to the measurement bit string, each row of pixels may further comprise an orientation bit, to indicate the orientation of the row of pixels to image processing software.

In addition to the measurement bit string, each row of pixels may further comprise one or more indicator bits to indicate whether the respective measurement value is odd or even. For example, each row of pixels may comprise a first indicator bit to indicate whether the respective measurement value is even, and a second indicator bit to indicate whether the respective measurement value is odd.

In one particular embodiment, each row of pixels comprises, in order, an orientation bit, a first indicator bit, the measurement bit string, and a second indicator bit.

Optionally, the order of the bits of the measurement bit string may be reversed depending on whether the respective measurement value is odd or even. Such reversal of the order of the bits of the measurement bit string provides a level of security/obfuscation in the binary encoding. Moreover, it also enables adjacent binary numbers to be more easily distinguished from one another by image processing software, as it results in an overall pattern that has more alternating black and white pixels, and fewer blocks of adjacent black pixels.

Alternatively, or in addition, the colours of the bits of the measurement bit string may be reversed depending on whether the respective measurement value is odd or even.

Preferably the width of the respective window, through which said portion of the measurement indica is visible in use, corresponds to the length of the row of pixels across the measuring tape.

To optimise the precision and resolution of the measurements made, preferably the successive rows of pixels are immediately adjacent to one another. However, in other variants they may be spaced apart from one another. In yet other variants, other types of measurement indicia are possible, such as human-readable numerals, for example.

According to a second aspect of the invention there is provided a method for measuring a foot using the device according to the first aspect, the method comprising: abutting the members of the device against respective portions of the foot, and in so doing, extending the respective measuring tape(s) to cause respective portion(s) of the measurement indicia, representative of the extent of extension of the measuring tape(s), to become visible in the respective window(s).

Preferably the method further comprises imaging, using a camera of a user device (such as a smartphone or tablet), the measurement indicia visible through the window(s); and processing (e.g. on the user device or a remote server) the imaged measurement indicia to determine corresponding measurement value(s).

When using a retailer's website or app, the method may further comprise: comparing prestored measurement data of a plurality of items of footwear to the obtained measurement value(s); determining the suitability of fit of available footwear relative to the obtained measurement value(s) based on the comparison; and displaying only footwear which are suitable based on the determination. Accordingly, by choosing from the so-displayed footwear, the user will obtain footwear that fits them well.

Alternatively, when using a retailer's website or app, the method may further comprise: receiving, from a user, a selection of an item of footwear, without reference to the size of the item of said footwear; comparing prestored measurement data of one or more available items of said footwear to the obtained measurement value(s); determining the availability of a suitability-fitting item of said footwear relative to the obtained measurement value(s) based on the comparison; and providing the suitable footwear based on the determination. Accordingly, in such a manner, the user will obtain footwear that fits them well, without potentially being misled by referring to conventional shoe-size labels or the like.

Alternatively, when shopping in a physical retail outlet, the method may further comprise: generating a code representative of the obtained measurement value(s); providing the generated code to a retailer device; comparing prestored measurement data of one or more available items of footwear to the measurement value(s) obtained via the code; determining the availability of a suitability-fitting item of footwear relative to the obtained measurement value(s) based on the comparison; and providing the suitable footwear based on the determination. Again, by virtue of this procedure, the user will obtain footwear that fits them well, without potentially being misled by referring to conventional shoe-size labels or the like.

According to a third aspect of the invention there is provided a computer program for causing a user device and/or a server to execute a method according to the second aspect.

According to a further aspect of the present disclosure there is provided a two-dimensional barcode extending in a first direction and in a second direction; wherein the two-dimensional barcode comprises a plurality of successive rows of pixels neighbouring each other in the first direction; and wherein each row of pixels extends in the second direction and uniquely encodes a respective value representative of position along the first direction. Preferably the successive rows of pixels are immediately adjacent to one another, to optimise the precision and resolution of the positional encoding.

Such a barcode may be employed for a variety of uses, including uses independent of the present measuring device and method.

Each row of pixels may comprise the respective value encoded into a binary bit string, wherein, in each bit string, pixels of a first colour denote bits of ‘1’, and pixels of a second colour denote bits of ‘0’.

The said bit string may comprise any suitable number of binary digits or bits. For example, it may comprise nine binary digits, although other numbers are also possible.

In addition to the said bit string, each row of pixels may further comprise an orientation bit to indicate the orientation of the row of pixels.

In addition to the said bit string, each row of pixels may further comprise one or more indicator bits to indicate whether the respective value is odd or even. For example, each row of pixels may comprise a first indicator bit to indicate whether the respective value is even, and a second indicator bit to indicate whether the respective value is odd.

In one particular example, each row of pixels comprises, in order, an orientation bit, a first indicator bit, the said bit string, and a second indicator bit.

Optionally, the order of the bits of the said bit string may be reversed depending on whether the respective measurement value is odd or even.

Alternatively, or in addition, the colours of the bits of the said bit string may be reversed depending on whether the respective measurement value is odd or even.

### BRIEF DESCRIPTION OF THE DRAWINGS

Embodiments of the invention will now be described, by way of example only, and with reference to the drawings in which:

FIG. 1 illustrates a perspective view of a device for measuring feet, in an open configuration;

FIG. 2 illustrates a perspective view of the device of FIG. 1, in a closed configuration;

FIGS. 3 and 4 illustrate respectively a plan view from above, and a plan view from underneath, of the device of FIG. 2;

FIGS. 5 and 6 illustrate respectively a longitudinal cross-sectional view, and a partial cutaway view, of the device of FIG. 2;

FIGS. 7, 8 and 9 illustrates cross-sectional views of the device of FIG. 2;

FIG. 10 illustrates a plan view (from above) of the device of FIG. 1, in its open configuration, as in use;

FIG. 11 illustrates a perspective view of the device of FIG. 1 in use, in a first measurement configuration;

FIG. 12 illustrates a perspective view of the device of FIG. 1 in use, in a second measurement configuration;

FIG. 13 illustrates (a) a front view of the device of FIG. 11 in the first measurement configuration, and (b) a front view of the device of FIG. 12 in the second measurement configuration;

FIG. 14 illustrates a side view of the device of FIG. 11 in use;

FIG. 15 illustrates a portion of a measuring tape as used in the device of the preceding figures, having, as measurement indicia, (a) a continuous two-dimensional barcode, (b) a series of discrete two-dimensional barcodes, and (c) numerals;

FIG. 16 illustrates a proprietary encoding methodology used in the continuous two-dimensional barcode of FIG. 15(a);

FIG. 17 schematically illustrates a measurement window with a measuring tape being in (a) a first position, and (b) a second position, such that a different unique portion of the barcode is visible in the window;

FIG. 18 schematically illustrates (a) a first measurement window having an identification mark that surrounds the window, and (b) a second measurement window having an identification mark at one corner of the window; and

FIG. 19 is a schematic plan view (from above) of the device of FIG. 1 as in use;

FIG. 20 is an overview of a system comprising a user device and a webservice, for use with the measuring device of FIG. 1;

FIG. 21 is a flow diagram showing an image processing procedure performed by the webservice of FIG. 20;

FIG. 22 is a flow diagram showing how the system may filter footwear for display to a user via a retailer's online channel (e.g. website or app) based on measurement data and stock for which a retailer has availability;

FIG. 23 is a flow diagram showing how the system may be used to provide well-fitting footwear to a user via a retailer's online channel (e.g. website or app) based on measurement data and stock for which a retailer has availability;

FIG. 24 is a flow diagram showing how the system may be integrated into physical retail stores; and

FIG. 25 illustrates a perspective view of a double-sleeve component for orthogonally aligning measurement tapes, as an alternative to the sleeve used in FIG. 1.

In the figures, like elements are indicated by like reference numerals throughout.

### DETAILED DESCRIPTION OF PREFERRED EMBODIMENTS

The present embodiments represent the best ways known to the Applicant of putting the invention into practice. However, they are not the only ways in which this can be achieved.

### Overview of the Measuring Device

The present disclosure provides a device which is suitable for accurately determining measurements of a foot, to enable correctly-sized footwear to be provided. It is particularly envisaged that the foot be that of a human, although the sizes of animal feet (e.g. horses) could also conceivably be measured using the present device (with the device potentially resized as appropriate), to enable correctly-sized shoes to be provided, or for other purposes such as veterinary research.

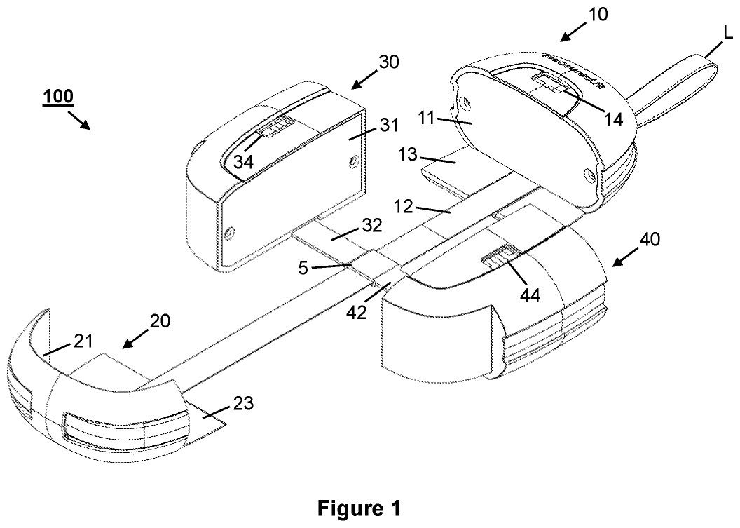

An example of the device 100 is shown in FIG. 1. The device 100 comprises a first member 10 having an inner face 11 for abutting against a first portion of the foot. With the illustrated device, the first portion of the foot is the toe end of the foot, and hence, in use, the inner face 11 of first member 10 is brought into contact with the furthermost toe of the foot being measured. The first member 10 also has an inwardly-extending horizontal base part 13, perpendicular to the inner face 11, on which base part 13 the user places their toes, thereby fitting the first member 10 accurately against the toe end of the foot. To facilitate ease of use, the first member 10 may optionally comprise a handle or lanyard L, which can be used to carry the device 100 and also aid in the positioning of the first member 10 around the foot in use.

The device 100 further comprises a second member 20 having an inner face 21 for abutting against a second portion of the foot. The second member 20 opposingly faces the first member 10. With the illustrated device, the second portion of the foot is the heel end of the foot, and hence, in use, the inner face 21 of the second member 20 is brought into contact with the heel of the foot being measured. It will be appreciated that the inner face 21 of the second member 20 is arc-shaped to fit around the heel of the foot. The second member 20 also has an inwardly-extending horizontal base part 23, perpendicular to the inner face 21, on which base part 23 the user places their heel, thereby fitting the second member 20 accurately around the heel end of the foot, and anchoring the device 100 against the ground in use.

To enable measurement of the length of the foot (i.e. between the inner face 11 of the first member 10 and the inner face 21 of the second member 20, along the foot's longest axis), the device further comprises a first extendable measuring tape 12, the tape 12 being defined by having a proximal end coupled to (and within) the first member 10, and a distal end extendable away from the first member 10, the distal end being coupled to the second member 20. The measuring tape 12 comprises measurement indicia printed (or otherwise displayed) along at least part of the length of the tape, such measurement indicia being used to convey measurement values in respect of the foot measurements taken by the device 100.

As described in greater detail below, to provide a high degree of precision in respect of the measurements that are made (i.e. to measure accurately, in small increments), to remove the possibility of human error when reading such measurements, and to permit digital integration with a system for providing correctly-sized footwear, the measurement indicia preferably comprises a continuous two-dimensional machine-readable (i.e. non-human-readable) barcode disposed along at least part of the length of the tape 12. A series of measurement values are uniquely encoded within the barcode, along its length. However, in variants of the device, other measurement indicia (such as discrete two-dimensional barcodes, or human-readable numerals or other codes) may be provided instead.

As illustrated, the first member 10 comprises a window 14 through which a portion of the measurement indicia, uniquely representative of the extent of extension of the first measuring tape 12 from the first member 10, is visible in use, and by means of which a corresponding measurement value may be obtained. With the measurement indicia being a machine-readable barcode, the measurement value is obtained by firstly capturing a digital image of the portion of the barcode that is visible through the window 14, e.g. using the camera of a mobile device such as a smartphone, and then decoding that portion of the barcode to obtain the corresponding measurement value. The encoded measurement value may be decoded from the captured image by image processing software running on the smartphone, or by a remote server (e.g. employing artificial intelligence or machine learning technology to improve the accuracy of the image detection) with which the smartphone is in communication. The measurement value so obtained may directly correspond to the distance between the first member 10 and the second member 20 (i.e. the length of the user's foot). Alternatively, the measurement value so obtained may not directly correspond to the distance between the first member 10 and the second member 20, in which case the software may process the measurement value in some way (e.g. by adding a calibration value to the measurement value) to obtain the corresponding length of the user's foot.

Thus, a measurement of the length of the foot, between the first (toe) and second (heel) portions, corresponding to the distance between the first member 10 and the second member 20, can be obtained by reading the extent to which the measuring tape 12 has been extended, as conveyed by the respective measurement indicia which are visible via the window 14.

To enable the user to rapidly and accurately obtain a width measurement as well as a length measurement, the illustrated device 100 further comprises a third member 30 having an inner face 31 for abutting against a third portion of the foot (e.g. the left side of the widest part of the foot) and a fourth member 40 having an inner face (not visible in FIG. 1) for abutting against a fourth portion of the foot (e.g. the right side of the widest part of the foot), the fourth member 40 opposing the third member 30.

Beneficially, by means of the third and fourth members 30, 40 as well as the first and second members 10, 20, the device 100 is able to measure the longest axis of the foot (heel to toe) in the manner described above, by using the first member 10 and the second member 20, while simultaneously measuring the widest portion (width) of the foot by placing the third member 30 and the fourth member 40 in contact with either side of the foot across its widest part (which is usually perpendicular to the foot's longest heel-to-toe axis).

With regard to the measurements themselves, the third member 30 is provided with a second extendable measuring tape 32 which has a proximal end coupled to (and within) the third member 30, and a distal end extendable away from the third member 30. Similarly, the fourth member 40 is provided with a third extendable measuring tape 42 which has a proximal end coupled to (and within) the fourth member 40, and a distal end extendable away from the fourth member 40, the distal end of the third measuring tape 42 being coupled to the distal end of the second measuring tape 32. As with the first measuring tape 12, these second and third measuring tapes 32, 42 also comprise measurement indicia which are used to convey measurement data in respect of the foot measurements taken by the device 100.

In this respect, as illustrated, the third member 30 comprises a window 34 through which a portion of the measurement indicia of the third measuring tape 32, uniquely representative of the extent of extension of the second measuring tape 32 from the third member 30, is visible in use, and by means of which a corresponding measurement value may be obtained. Similarly, the fourth member 40 comprises a window 44 through which a portion of the measurement indicia of the third measuring tape 42, uniquely representative of the extent of extension of the third measuring tape 42 from the fourth member 40, is visible in use, and by means of which a corresponding measurement value may be obtained. The measurement values obtained by the third and fourth members 30, 40 may be summed together to obtain the distance between the third member 30 and the fourth member 40 (i.e. the width of the user's foot), either directly from the summed measurement values or by further processing of those values in some way (e.g. by applying a calibration value).

Beneficially, in the illustrated example the distal end of the third measuring tape 32 is coupled to the distal end of the second measuring tape 22 by means of a sleeve 5 through which the first measuring tape 12 slidably passes. This enables the third and fourth members 30, 40 to be slidably placed at a range of longitudinal positions between the first and second members 10, 20, thereby enabling the widths of differently-shaped feet to be readily measured.

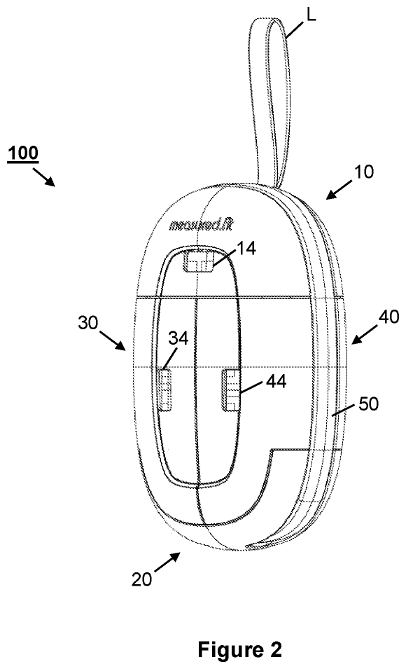

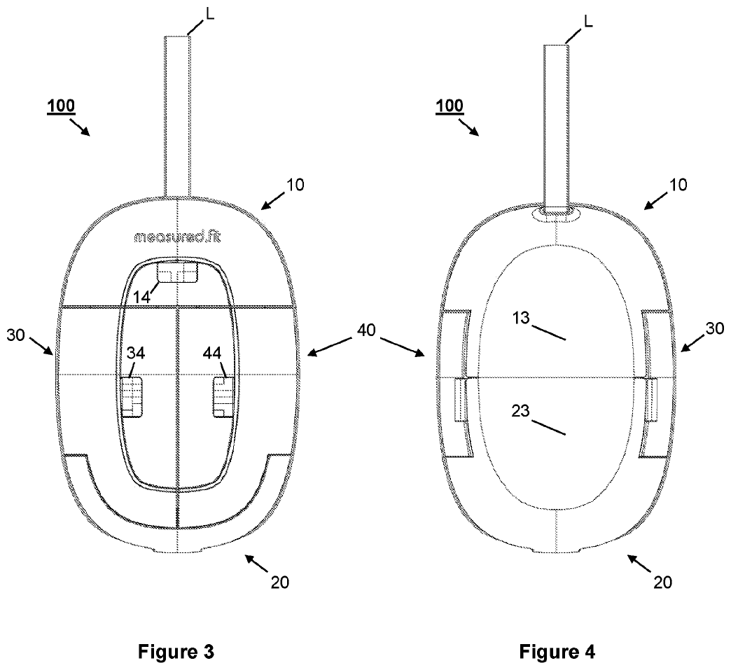

With the illustrated device 100, the first to fourth members 10, 20, 30, 40 are mutually configured such that, by retracting the tapes 12, 32, 42, the members 10, 20, 30, 40 tessellate or interlock with respect to one another, to enable the device 100 to adopt a closed configuration, thereby enabling device 100 to be stored or carried compactly. In this regard, reference is now made to FIGS. 2, 3 and 4, which respectively illustrate the device 100 in a perspective view, a plan view and an underneath view, when the device 100 is in its closed configuration.

To facilitate said tessellation, each of the members 10, 20, 30, 40 comprises respective coupling means, such as magnets (not shown), which mutually engage with a neighbouring member. For instance, the first and second members 10, 20 may comprise magnets which respectively couple to magnets located on the third and fourth members 30, 40.

When the members 10, 20, 30, 40 come together to adopt the closed configuration, the above-described base parts 13 and 23 of the first and second members 10, 20 together form a base on which to support the third and fourth members 30, 40, thus improving the overall rigidity of the device 100 when in the closed configuration.

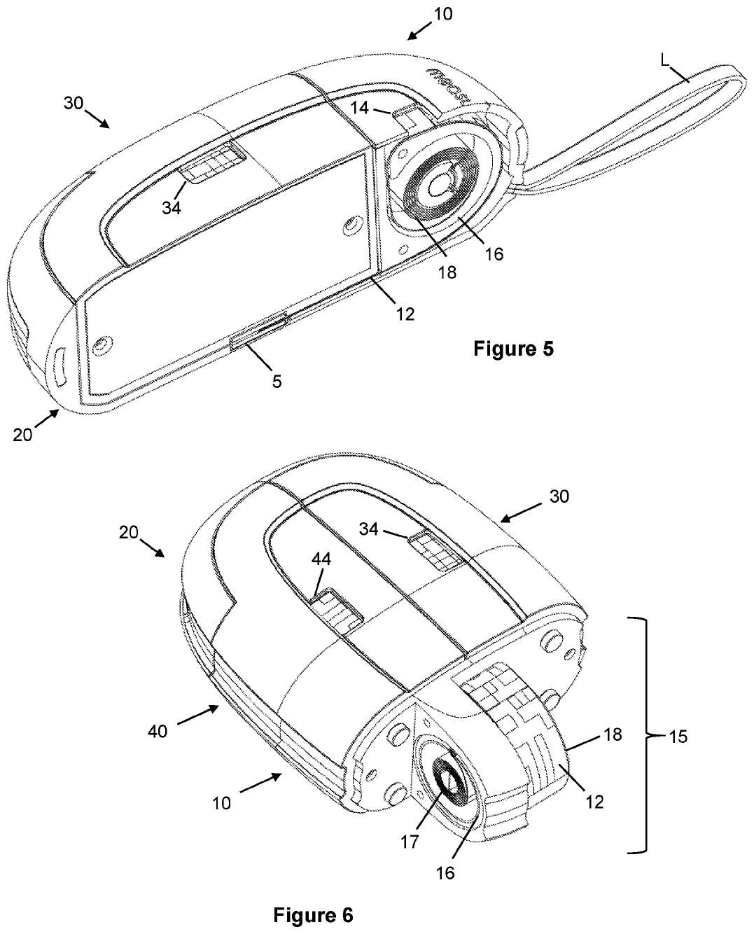

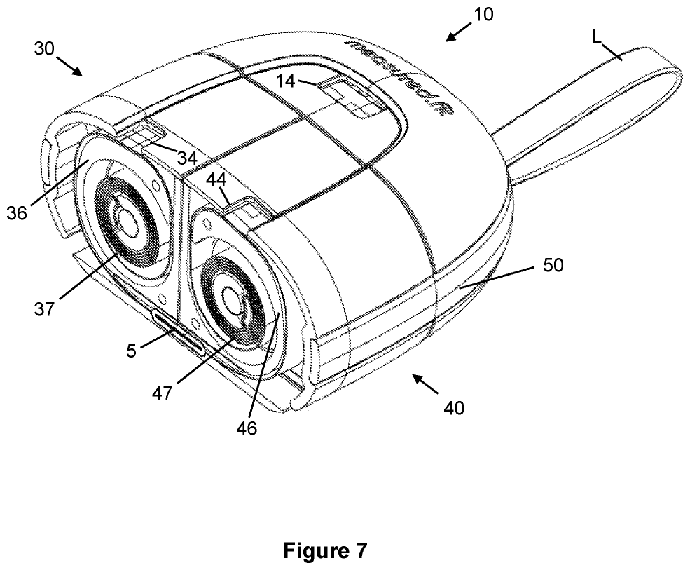

As shown in FIGS. 5 and 7, when the device 100 is in the closed configuration the sleeve 5 is compactly housed within a recess formed within and between the third and fourth members.

To further secure the four members 10, 20, 30, 40 together when in the closed configuration, an additional strap 50, connected to e.g. the second member 20, may be provided which wraps around the device 100, fitting within an appropriately sized groove formed around the periphery of the device 100, within each of the first to fourth members. The strap 50, once having been wrapped around the respective members, is secured to the member to which it is connected (second member 20 in this example) by way of a coupling means, such as a magnet, buckle or other detent mechanism. To facilitate a good fit into the groove, the strap 50 may be formed of an elastomeric material, such as rubber, although it should be appreciated that the strap 50 may instead be formed of other suitable materials. As discussed in greater detail below, the strap 50 may also be used to obtain a measurement around the heel of the user (a so-called “long heel” measurement).

### Internal Features of the Members, Including Spring-Biased Spool and Tape Guide Structure

Turning now to FIGS. 5 and 6, FIG. 5 shows a longitudinal cross-section of the device 100, in which the internal mechanics of the first member 10 can be seen in detail, while FIG. 6 shows the first member 10 with its outer casing (also called a spool cover casing) omitted (cut away) for clarity.

FIGS. 5 and 6 together illustrate that the first member 10 comprises a spool holder 15 which, for example, is screwed or secured by some other means into the interior shell of the first member 10. The spool holder 15 comprises an internal guide structure 16 for the measuring tape 12, a spool 18 on which the tape 12 is wound (when retracted), and a spring 17 (e.g. a constant force torsion spring) which acts to bias the spool 18 and the tape 12 thereon into a retracted state. It can be seen that the spool 18 and the tape 12 are aligned with the centreline of the first member 10, such that the tape 12 is aligned with the window 14, whereas the torsion spring 17 is off-centre relative to the centreline of the first member 10.

The spool 18 is configured to rotate freely around a shaft provided within the cover of the spool holder, the cover being screwed into the spool holder 15 each side of the spool holder 15.

During assembly of the device, the torsion spring 17 is mounted inside the spool 18, on the opposite side to the tape 12. In the present example, an outer end of the spring locates into a slot on the outer circumference of the spool 18, and an inner end of the spring locates into a slot on the end of the shaft which is provided within the spool holder cover, thereby providing an anchor point from which the spring 17 can exert its biasing force.

The measuring tape 12 is loaded onto the spool 18 by the action of the biasing force exerted by the torsion spring 17, which biases the measuring tape 12 into the retracted state. In the present example, the measuring tape 12 is attached to the spool 18 by a loop passing over a post located on the spool 18.

During extension of the measuring tape 12, as in use, the tape 12 is guided from the spool 18 by a tape guide structure 16. The guide structure 16 is adapted to guide the tape 12 across (and closely underneath) the viewing window 14, around an outer space inside the first member 10, and then out through an aperture or slot in the underside of the first member 10.

Once the desired measurement(s) have been taken, e.g. by obtaining the value of the measurement indicia indicated via the window 14, the user may release the first member 10 and the action of the biasing force of the spring 17 will retract the measuring tape 12 back onto the spool 18 for storage within the first member 10.

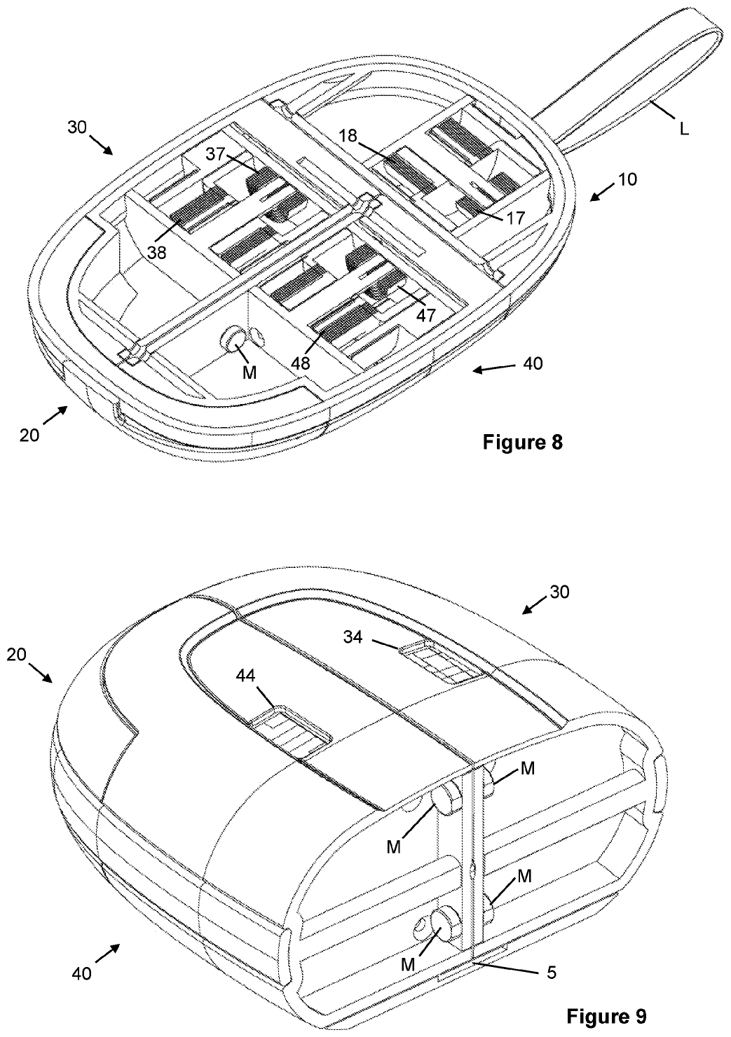

FIGS. 7 and 8 illustrate, in cross-section, the corresponding associated internal mechanics of the third member 30 and the fourth member 40. Each of these members 30, 40 also comprises an equivalent spool holder to spool holder 15, and hence the spool holder of each of the third and fourth members 30, 40 comprises a respective tape guide structure 36, 46, a respective spring 37, 47, and a respective spool 38, 48.

Accordingly, in a manner similar to the measuring tape 12 of the first member 10, the measuring tapes 32, 42 of the third and fourth members 30, 40 are loaded and stored on their respective spools 38, 48 by action of the biasing force of the respective springs 37, 38. Similarly, during extension of the tapes 32, 42 as part of the measurement process, the tapes 32, 42 are guided from their respective spools 38, 48 by the respective tape guide structures 36, 46, across their respective viewing windows 34, 44, around an outer space inside each member, and out through an aperture or slot in the underside of each member.

In more detail, FIG. 8 provides a cross-sectional perspective view of device 100, showing the respective springs 17, 27, 37 and spools 18, 28, 38 of each of the first to third members 10, 20, 30 for storing the associated measuring tapes when the device 100 is not in use.

The mutual configuration of the respective springs 17, 27, 37 and spools 18, 28, 38 of the first to third members 10, 20, 30 facilitates the biasing of the first to third members 10, 20, 30 into the closed configuration when the device 100 is not being used, bringing the first to fourth members 10, 20, 30, 40 adjacent to one another and assisting with the tessellation of the device 100 into the closed configuration.

As illustrated in FIGS. 8 and 9, coupling means M (e.g. magnets) further facilitate said tessellation. Each member 10, 20, 30, 40 of device 100 comprises respective magnets M, which mutually engage with a neighbouring member. For instance, the first and second members 10, 20 comprise magnets which respectively couple to magnets located on the third and fourth members 30, 40.

### Measurement of Feet

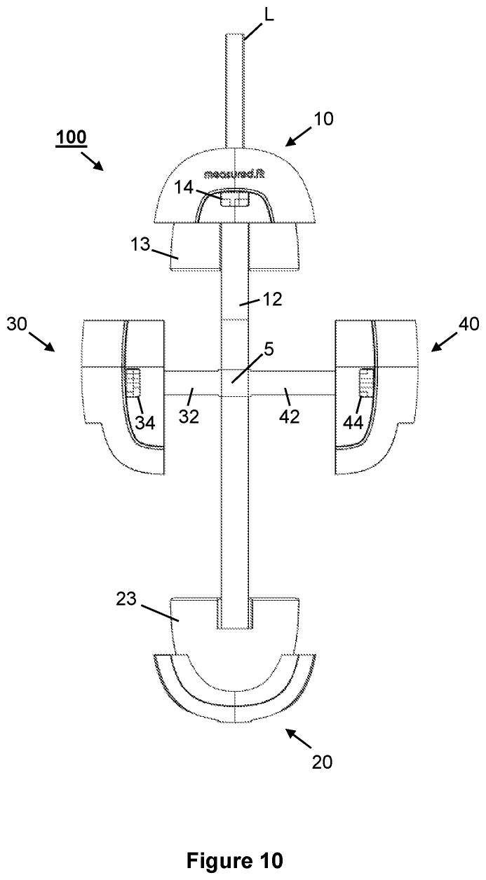

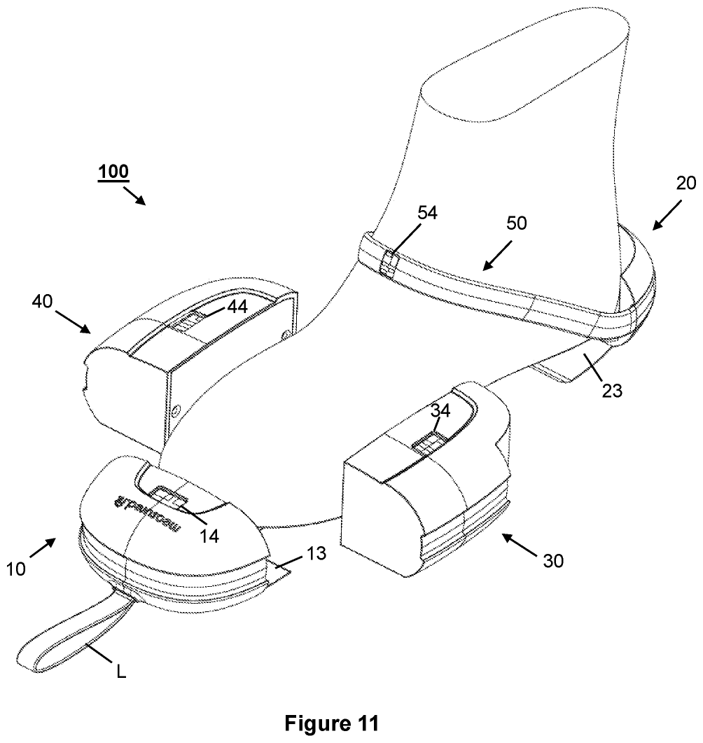

Turning now to FIG. 10, device 100 is shown in plan view in its open configuration, and FIG. 11 shows the device 100 in perspective view with the first, second, third and fourth members 10, 20, 30, 40 abutting against respective portions of a foot.

In use, the user extends the measuring tape 12 of the device 100 and abuts the second member 20 against and around the heel of the foot, as shown in FIG. 11 (and, in so doing, anchoring the device on the ground by means of the base part 23). The first member 10 is abutted against the furthermost toe of the foot (further anchoring the device on the ground by means of the base part 13). Having extended the measuring tape 12, measurement indicia on the tape are revealed through the first window 14, corresponding to the extent of extension of the tape 12. A corresponding measurement value in respect of the length of the foot (i.e. of the foot's longest axis) can then be obtained from the measurement indicia shown in the first window 14.

In a similar manner, the user extends the respective measuring tapes 32, 42 of the third and fourth members 30, 40, and places these members at the widest part of the foot. The extent of extension of the second and third measuring tapes 32, 42 are respectively indicated via the measurement indicia revealed through the window 34 on the third member 30 and the window 44 located on the fourth member 40.

Corresponding measurement values obtained from the indicia shown in the third and fourth windows can then be summed to obtain a measurement of the width of the foot.

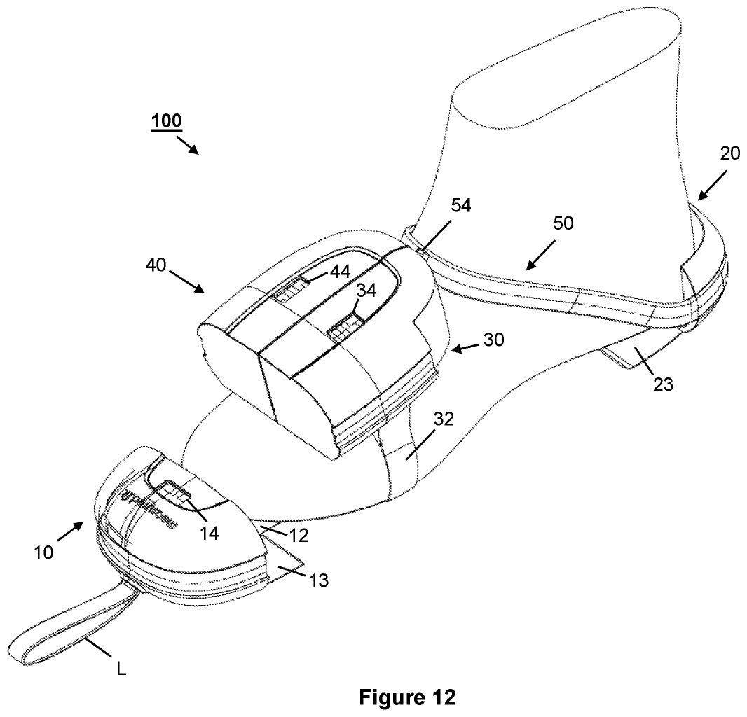

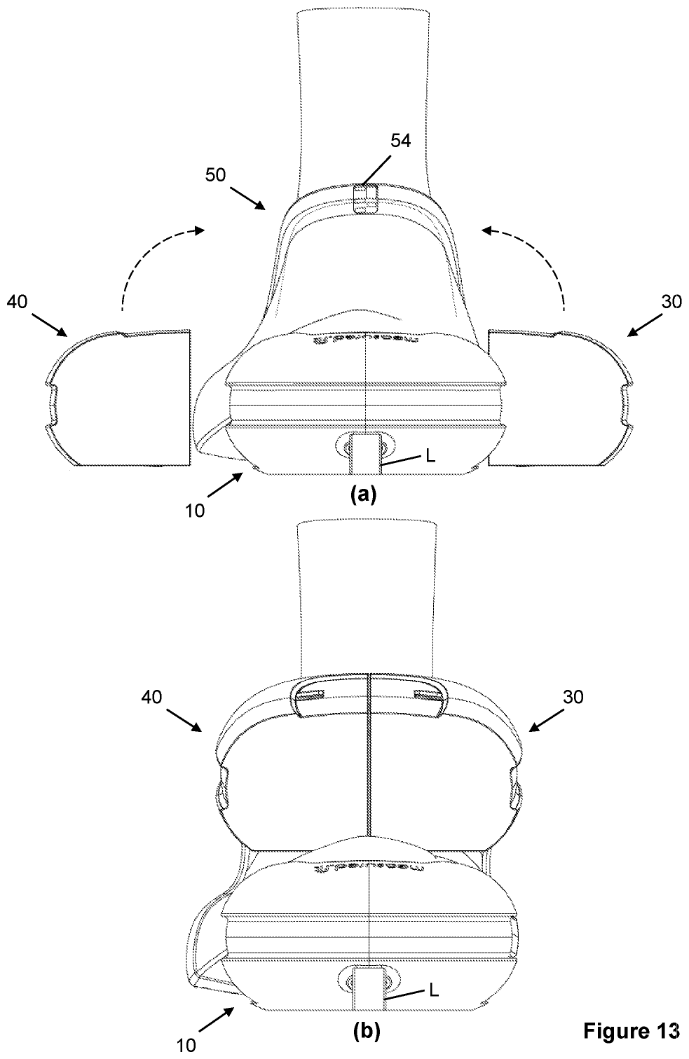

Reference is now made to FIGS. 12 and 13. As illustrated in this example, the third and fourth members 30, 40 may beneficially mutually couple to one another (e.g. by way of a coupling means, such as a magnet, which is not shown) by further extension of their respective measuring tapes 32, 42, over the top of the foot, until coupled. Further respective measurements can then be obtained from the measurement indicia respectively displayed at each of the windows 34 and 44, which, upon summing, provides a girth measurement of the foot.

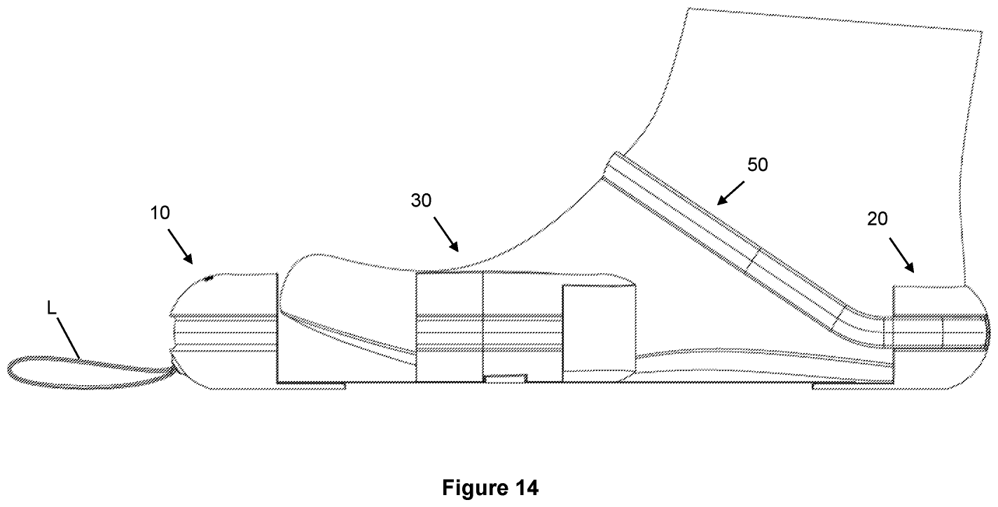

As shown in FIG. 14, the device may further comprise an additional measuring strap 50, which is anchored to the second member 20 by means of an anchoring point. The anchoring point may for example be a loop formed within the second member 20, through which the strap 50 passes. The strap 50 may be configured to wrap around the heel of the foot being measured and to couple to a coupling point on the second member 20, opposite to the strap's anchoring point. The measurement obtained by the measuring strap 50 may be referred to as a “long heel” measurement. Measuring strap 50 may incorporate any suitable measuring means with associated measurement indicia, such as a continuous two-dimensional barcode as described herein. For instance, the continuous two-dimensional barcode may be printed (or otherwise displayed) along at least part of the strap 50, and the end of strap may be arranged to pass through a buckle or other housing in which a measurement window 54 is provided, in the manner of the other measuring tapes and measurement windows described herein.

Measurement Indicia

As set out above, the device 100 is suitable for measuring several different portions of a foot, with the measurement indicia of the respective measuring tapes conveying a series of different measurement values via the windows located on the members of the device.

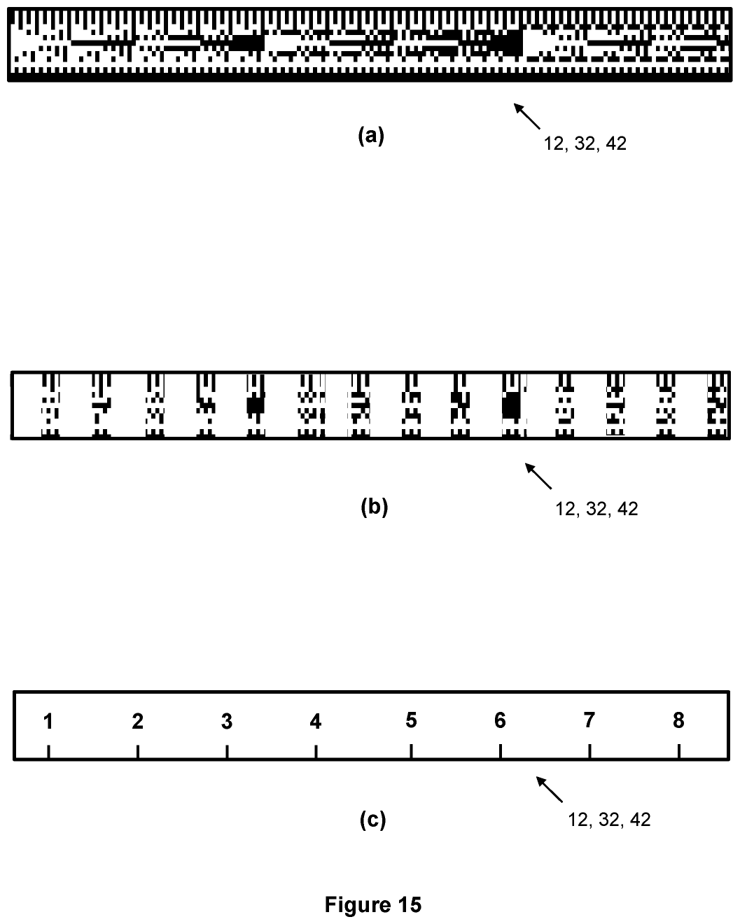

With reference to FIG. 15, various examples of measurement indica are shown on a portion of a measuring tape. The measurement indicia may be printed (or otherwise displayed) along the entire length of the tape, or along only part of the length of the tape corresponding to a range of expected measurement values. In other words, there is no need to provide measurement indicia along those parts of the tape that will never be aligned with the respective window during normal measuring operations.

Preferably the measurement indicia are intended to be machine-readable (e.g. by means of a smartphone camera) rather than human-readable, to remove the possibility of human error, to provide a high degree of precision in respect of the measurements that are made (i.e. to measure accurately, in small increments) and to permit digital integration with a system for providing correctly-sized footwear. The measurement indicia may directly correspond to actual measurement values, or may correspond to code numbers from which the actual measurement values may then be obtained, e.g. by means of a look-up table or by applying a calibration value.

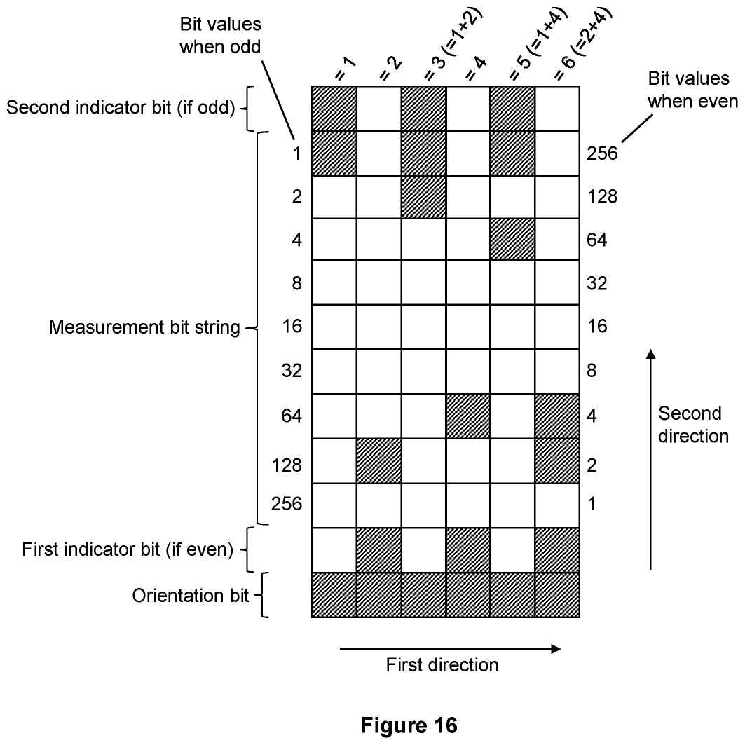

FIG. 15(a) illustrates a presently-preferred example whereby the measurement indicia on the measuring tape are in the form of a continuous two-dimensional barcode, encoded by means of a proprietary encoding methodology (as described below with reference to FIG. 16). Successive rows of pixels, along the length of the tape, are encoded to represent unique decimal numbers in binary, the underlying encoding having been performed by carrying out decimal to binary conversion. Beneficially, during measurement, a unique portion of the barcode is revealed in the respective viewing window of the device, representing the extent of extension of the respective measuring tape from the respective member, relative to a predefined origin.

The pixels of the two-dimensional barcode, and the corresponding size of the window through which the unique portion of the barcode is revealed, can be as small as the imaging and decoding technology permits, thereby enabling a high degree of measurement precision, with small measurement increments—potentially smaller than would otherwise be conveyed by human-readable indicia. This is enhanced by the barcode being continuous, rather than having gaps between neighbouring encoded values (as such gaps do not convey information and decrease the achievable measurement resolution). With a continuous barcode, the degree of measurement precision (i.e. the incremental distance between successive measurements) corresponds to the size of the pixels in the barcode. The pixels may measure, for example, 1 mm by 1 mm, or 1.5 mm by 1.5 mm, or 2 mm by 2 mm, or 2.5 mm by 2.5 mm, or 3 mm by 3 mm, or any other suitable size. Moreover, although the present pixels are shown as being square, this need not be the case, and they may instead be rectangular, for example.

More particularly, and with reference to FIG. 16, the two-dimensional barcode of FIG. 15(a) extends in a first direction along at least part of the length of the respective measuring tape, and in a second direction across at least part of the width of the measuring tape.

The two-dimensional barcode comprises a plurality of successive rows of pixels neighbouring each other in the first direction, wherein each row of pixels extends in the second direction and uniquely encodes a respective measurement value.

As those skilled in the art of barcodes will appreciate, the pixels may be black and white regions, although other sufficiently contrasting colours may be used instead.

Each row of pixels comprises the respective measurement value encoded from decimal into a binary measurement bit string, wherein, in each measurement bit string, pixels (i.e. blocks) of a first colour (e.g. black) denote bits of ‘1’, and pixels of a second colour (e.g. white) denote bits of ‘0’. With the coding methodology illustrated in FIG. 16, the measurement bit string comprises nine binary digits (bits), representing decimal values of 256, 128, 64, 32, 16, 8, 4, 2 and 1, although in other variants additional (or fewer) binary digits may be included in the bit string. Thus, according to conventional decimal to binary conversion, a decimal measurement value of 5 will be denoted by 000000101 (0x256, 0x128, 0x64, 0x32, 0x16, 0x8, 1×4, 0x2, 1x1), whereas a decimal measurement value of 171, say, will be denoted by 010101011 (0x256, 1x128, 0x64, 1x32, 0x16, 1x8, 0x4, 1x2, 1x1). Using nine bits enables over 500 unique measurement values to be encoded (as 111111111 in binary is the decimal value 511).

However, it will be noted that, in the encoding methodology illustrated in FIG. 16, each row of pixels contains more than just the nine-bit measurement bit string. In addition to the measurement bit string, each row of pixels further comprises an orientation bit (in the first bit position, at one end of the row of pixels, at the bottom as illustrated) to indicate the orientation of the row of pixels. Since this orientation bit is common to all the rows of pixels, it is visually equivalent to a solid black (or other colour) line running along the length of the barcode. This enables the image processing software to readily determine the orientation of the barcode, by identifying which side of the barcode has the solid line.

With the encoding methodology illustrated in FIG. 16, in addition to the measurement bit string and the orientation bit, each row of pixels further comprises one or more indicator bits to indicate whether the respective measurement value is odd or even. More particularly, as illustrated, each row of pixels comprises a first indicator bit (in the second bit position) to indicate whether the respective measurement value is even (i.e. it is set to 1 if the measurement value is even, and to 0 if the measurement value is odd).

Optionally, but advantageously, to provide greater resilience, with the illustrated methodology each row of pixels also comprises a second indicator bit (in the twelfth bit position, at the top as illustrated) to indicate whether the respective measurement value is odd (i.e. it is set to 1 if the measurement value is odd, and to 0 if the measurement value is even; the reverse of the first indicator bit).

In conjunction with the orientation bit, the first and second indicator bits form a pattern that provides additional resilience in respect of enabling the orientation of the barcode to be determined.

Moreover, in the illustrated methodology, the order of the bits of the measurement bit string is reversed, depending on whether the respective measurement value is odd or even (as denoted by the first and second indicator bits). Thus, in the illustrated methodology, for odd numbers the third to eleventh bit positions (i.e. the bits of the measurement bit string) correspond to 256, 128, 64, 32, 16, 8, 4, 2 and 1 respectively. On the other hand, for even numbers, the third to eleventh bit positions (i.e. the bits of the measurement bit string) correspond to 1, 2, 4, 8, 16, 32, 64, 128 and 256 respectively. In other words, in the illustrated example, odd numbers always begin “top down” (since “1” is at “the top” and all odd numbers in binary end with a “1”), and even numbers begin “bottom up” (since 2 is near to “the bottom”).

By reversing the order of the bits of the measurement bit string in the above-described manner, this provides a level of security/obfuscation in the binary encoding. Moreover, it also enables adjacent binary numbers to be more easily distinguished from one another by the camera and software, as it results in an overall pattern that has more alternating black and white pixels, and fewer blocks of adjacent black pixels.

The present two-dimensional barcode is configured such that it is not human readable (so as to remove instances of human error), accurate (supporting small increments in measurements), resilient to obscured bits, readable from any angle, and visually distinct from a QR code (so that a smartphone camera does not automatically attempt to process it with QR reader software).

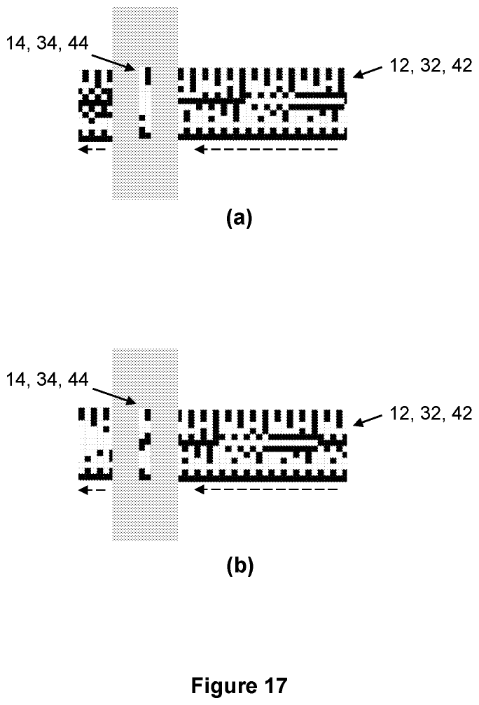

Referring now to FIGS. 17(a) and 17(b), in the illustrated example the windows 14, 34, 44 of the respective first to third members 10, 30, 40 of device 100 are sized so as to allow two rows of the two-dimensional barcode's data to be visible at any one time. In other variants, the windows may be sized differently, such that a different number of rows of the two-dimensional barcode's data are visible—e.g. one row, two rows, three rows, or more than four rows. It will be appreciated that, each time a row of two-dimensional code data is incremented, e.g. by the measuring tape extending from right to left as indicated by the dashed arrows in FIGS. 17(a) and 17(b), a new overall portion of two-dimensional code is displayed in the window, representing the corresponding measurement value.

Turning back to FIG. 15, FIGS. 15(b) and 15(c) illustrate comparative examples of alternative forms the measurement indicia may take, along the length of a portion of a measuring tape.

More particularly, FIG. 15(b) illustrates a comparative example of measurement indicia comprising discrete two-dimensional codes, corresponding to separate spaced-apart measurement values. It will be appreciated that such an encoding technique offers less measurement resolution than the continuous two-dimensional barcode of FIG. 15(a) as described above.

Finally, FIG. 15(c) illustrates a comparative example of measurement indicia comprising a series of numerals, that may be read by a human. The numerals may, for instance, correspond to measurements in millimetres, centimetres, or inches. Alternatively, these numerals may correspond to standard shoe sizes, such as UK shoe sizes 1, 2, 3, etc. Whilst such numerals are able to be read by humans without the need for a smartphone camera and image processing system, they are prone to human error (e.g. misreading the numerals), and do not readily enable digital integration with a system for providing correctly-sized footwear. Accordingly, in the present disclosure, the above-described two-dimensional barcodes (in particular, of the continuous type as illustrated in FIGS. 15(a) and 16) are preferred, in order to provide greater accuracy and precision, as well as permitting digital integration with a system (e.g. using a mobile app and a webservice) for providing correctly-sized footwear, as described below.

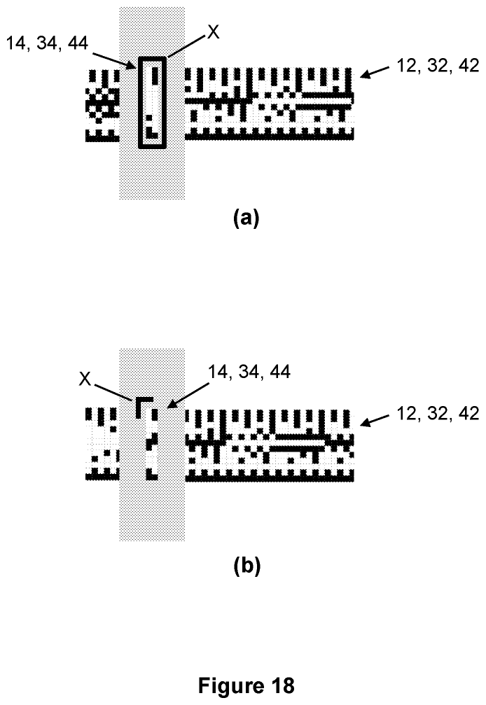

Reference is now made to FIGS. 18(a) and 18(b). It will be appreciated that these figures correspond to FIGS. 17(a) and 17(b), but showing the addition of an optional respective identifying marker X located around or adjacent to at least part of the window, by means of which the window (and thus the member on which the window is provided) can be uniquely identified by the image processing software. This ensures that the imaged measurement indicia and the resulting measurement data will be correctly processed and stored with respect to the respective member on which the identifying marker in question is applied. For example, the identifying marker X may be around the entire window (as in FIG. 18(a)) or in one corner of the window (as in FIG. 18(b)). It will be appreciated that the absence of an identifying marker around a particular window may also enable that window to be uniquely identified, if all the other windows have identifying markers. The shape of the markers can also be used to guide the user to place the respective members 10, 20, 30, 40 in the correct locations, by reference to a given marker. For instance, the marker used in FIG. 18(a) may be used to denote that the member having this marker ought to be placed at the toe portion of the foot. The windows may also, or alternatively, have unique shapes or aspect ratios, by means of which they can be uniquely associated with the respective members by the imaging processing software.

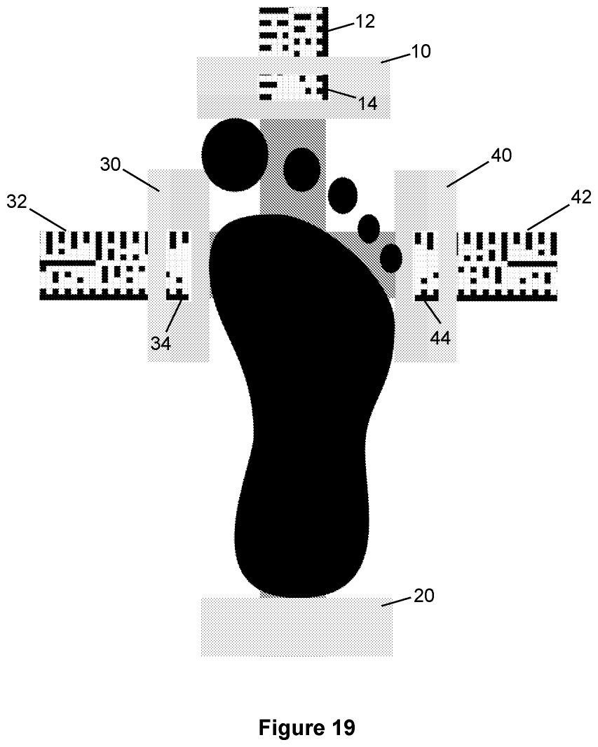

It will of course be appreciated that the above-described two-dimensional barcodes (preferably of the continuous type as illustrated in FIGS. 15(a) and 16) enable measurement data to be acquired from multiple measuring tapes in use. This is schematically illustrated in FIG. 19, which depicts the device 100 in plan view. As illustrated, the first and second members 10, 20 have been placed in contact with the furthermost toe and the heel respectively, by extending the tape 12 to receive the foot being measured. Accordingly, a portion of the measurement indicia (two-dimensional barcode) is visible through window 14, the portion of measurement indicia corresponding to the extent of extension of the tape 12, and therefore corresponding to the length of the foot along its longest axis.

Similarly, third and fourth members 30, 40 have been placed in contact with widest portion of the foot, by extending tapes 32, 42 respectively to receive the foot. Again, portions of the measurement indicia (two-dimensional barcodes) are visible through respective windows 34, 44, with each displayed portion of the measurement indicia corresponding to the extent of extension of the respective tape 32, 42—and therefore, when the values indicated by both these portions of measurement indicia are summed, denoting the width of the foot.

### Mobile Application and Webservice

A mobile application (app) will now be described. The app may be used in combination with the above-described device 100 to obtain precise measurements of a foot (as well as to provide appropriate footwear recommendations based on the obtained measurements). The app itself is a user access application that, when installed (e.g. on a smartphone, tablet, or other suitable mobile device having a camera), enables images of the above-described measurement indicia in the windows to be captured and the corresponding measurement values to be determined, either within the mobile device itself or via an associated webservice.

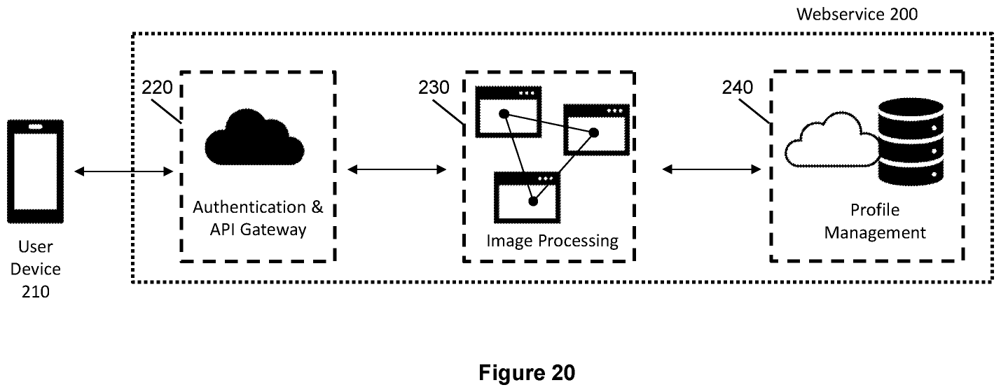

In this regard, FIG. 20 schematically illustrates the interaction between the mobile application (app) running on a user device 210 (such as a smartphone or a tablet) and the associated webservice 200 with which the app interfaces. The webservice 200 is a multi-functional online service which handles most of the processing, data exchange and storage required to provide the services in question. The webservice may be developed using any suitable programming language, such as Golang, Python or Javascript, and advantageously may be powered by Google Cloud Platform for redundancy and scalability.

The webservice 200 is comprised of several modules 220, 230, 240, each handling a specific set of tasks, namely an Authentication & API Gateway module 220, an image processing module 230, and a profile management module 240.

Specifically, the Authentication & API Gateway module 220 is responsible for user and merchant registration and authentication. This module 220 is configured to load-balance access to the other modules 230, 240.

The image processing module 230 is configured to perform two main functions, namely detection and verification/decoding of images taken by the user of the user device 210 and uploaded to the webservice from the mobile app running on that device 210. When a user uploads a photo of one of the windows 14, 34, 44 and the measurement indicia therein (of the first, third or fourth members 10, 30, 40) this module 230, using a trained neural network, detects and identifies the measurement represented by the measurement indicia.

The Profile Management module 240 is configured to store and retrieve user profiles and foot measurements for a given customer, to encrypt data, and to map each user's foot measurements to the corresponding measurements of a footwear manufacturer's “last”, as stored in or available through the webservice (a “last” being a foot-shaped form on which items of footwear are made).

Initially, users of the app create an account with the system. In this regard, the user may provide general signup information, such as their name (or a username), gender, email address and a password.

Once the user has set up an account, the app then prompts the user through the measurement process described above. The app will firstly request the user to indicate which foot measurement is being taken (i.e., left foot or right foot). The user then uses the camera of their mobile device to capture images of the measurement indicia (e.g. two-dimensional barcodes) visible in the respective windows, corresponding to each of the foot measurements as described above (i.e., typically, “heel to toe”, “width”, “girth”, and optionally “long heel”). The app may prompt the user as to the specific sequence of the images to be captured. Alternatively, as described above with reference to FIGS. 18(a) and 18(b), each window may be provided with an identifying marker (or the absence of such a marker) by means of which the window can be uniquely recognised by the image processing software; in such a case, the user can capture the images in whichever order they wish (the system can automatically distinguish between the width and girth measurements, despite them using the same windows and measuring tapes, because the girth measurements will be greater than the corresponding width measurements). After each image is captured, it is uploaded to the webservice for processing, to determine the respective measurement encoded therein. The summing operations associated with the width and girth measurements are performed automatically.

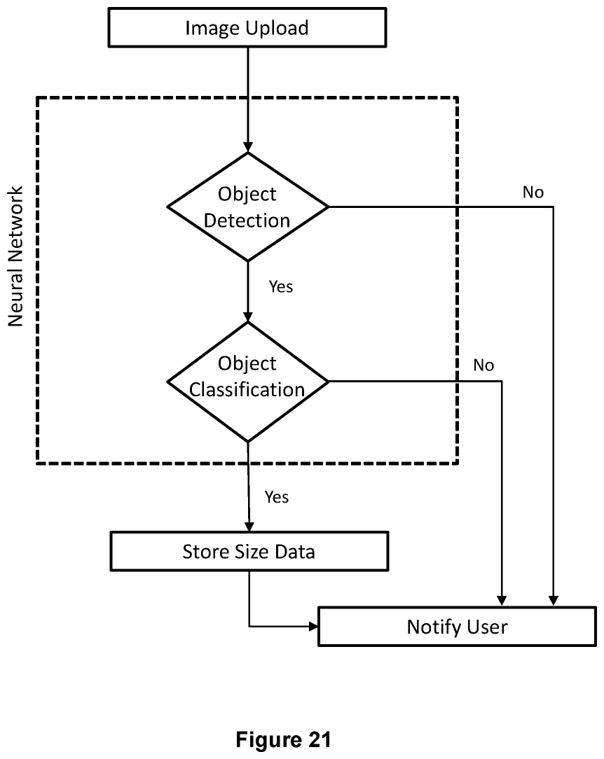

FIG. 21 is a process flow diagram which illustrates the steps taken by the image processing module 230.

Preferably the image processing is performed by use of a neural network. The neural network first determines if an object, such as a portion of a continuous two-dimensional barcode in a respective window, is present. If an object is not present (e.g. the processing fails to due to poor image resolution, low-light, etc.), then the user is notified that the image needs to be recaptured. If an object is detected, the neural network then classifies each object according to input data, e.g. the first member 10 of the left foot would be classified as such, and the imaged measurement indicia indicated via the respective window 14 would be stored relative to this classification. The size data encoded by the two-dimensional barcodes is decoded and stored in association with the classified object for that user.

Where the measurement indicia comprise a two-dimensional continuous barcode, there may be instances where rows of barcode data are only partially visible within the respective window. For instance, instead of two complete barcode rows being visible, half the width of a first row, a complete second row, and half the width of a third row may be visible. In other instances, some of the pixels of the barcode rows may be obscured by suboptimal lighting conditions or dirt, for example. The neural network is still able to decode size information in such cases, either by decoding a partial-width row in the same manner as a full-width row, or by comparing the incompletely-imaged barcode rows with pre-processed known portions of the barcode data stored in the neural network, to compensate for incomplete rows being presented as an image input, and thereby decode the measurement data.

If multiple barcode rows are imaged and decoded within a single window, a mean average of the corresponding measurement values may be taken as the overall measurement value in respect of that window.

Advantageously, by use of the continuous two-dimensional barcode in the present manner, a high-level of resolution can be achieved (e.g. to within 1.5 mm accuracy), enabling sizes to be determined with a high degree of precision without operator error (e.g. avoiding human error introduced by misreading of the measurement indicia of a traditional tape measure).

Once the user's feet measurement data have been successfully processed and stored against a user profile, the system may make various recommendations to the user based on the stored data, as discussed in detail in the following section.

### Integration With Retailers

As part of creating any footwear, a footwear manufacture may define all the measurement dimensions of the footwear, as well as the last to be used in the manufacture of that footwear. Therefore, the actual measurement data that corresponds to every pair of footwear manufactured by a given footwear brand may be known and may be stored (e.g. on a server). This stored measurement data of the manufactured items of footwear forms the basis for retailer integration with the above-described webservice.

Accordingly, the feet measurement data of the user, obtained via the app and stored in the system (e.g. the above-described webservice), may be compared against the actual physical measurements of a specific pair of footwear being offered for sale by a retailer (rather than the semi-standardised sizing information that would conventionally be provided, e.g. on a label). In particular, the actual physical measurements of the footwear may correspond to the dimensions of the last used in manufacturing the footwear. So, by comparing the feet measurement data of the footwear buyer with the measurement dimensions of the footwear last, a recommendation (or confirmation) as to footwear that will fit the user well can be made with high accuracy.

There are several ways in which the system can be configured to integrate with a footwear retailer, as set out as follows.

### Filtering Stock on a Website

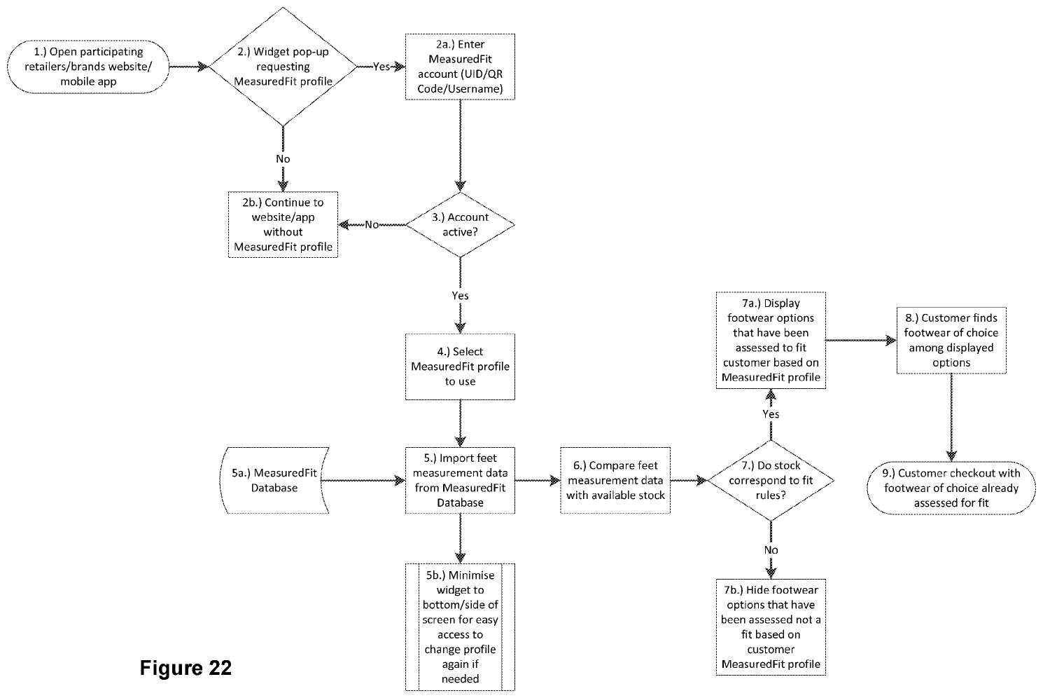

Reference is now made to FIG. 22, which sets out a process for filtering stock on a retailer's website/app by considering measurement data stored by the system, by use of a proprietary widget integrated within the website or app.

In step 1, a potential purchaser (referred to hereinafter as a user) of footwear navigates to a footwear retailer's website (or accesses an app provided by that retailer, etc.). In step 2, the user is requested to log in to their “MeasuredFit” account if they have one (where “MeasuredFit” refers to the present system, app and webservice). If they have such an account, then in step 2a they enter it (by providing appropriate login details). On the other hand, if they do not have such an account then the process ends at step 2b with the user proceeding to use the website without the benefit of the MeasuredFit functionality.

In step 3, a determination is made as to whether or not the user has a valid and active MeasuredFit account. If not, then the process ends at step 2b, else the procedure continues in step 4 and the user selects a MeasuredFit profile to use (e.g. their personal profile, if the account applies to more than one user, such as members of the user's family).

Once a profile has been selected, in step 5 the widget imports the measurement data stored against the selected user's profile from the MeasuredFit system's database (minimising the widget in step 5b to e.g. to the bottom/side of the display for easy access to change user profile again, if needed).

In step 6, the retailer's website compares the user's measurement data against their available stock and then, in step 7, a determination is made as to whether items of footwear in the retailer's available stock are suitable to fit the user based on the user's measurement data. Accordingly, in step 7b, in-stock footwear which would not fit the user is hidden from their view, and only footwear which fits, based on the provided measurement data, is presented (step 7a).

Beneficially, therefore, the system when integrated with a retailer's website/app ensures that a user is only presented with footwear having dimensions which match the user's measurement data (as held in their MeasuredFit profile), thereby ensuring that the user is able to obtain footwear having a correct fit.

The user may then select and buy the footwear which they deem the most appropriate for their needs (respectively steps 8 and 9).

### Changing the Process of Selecting Footwear Sizes on a Website

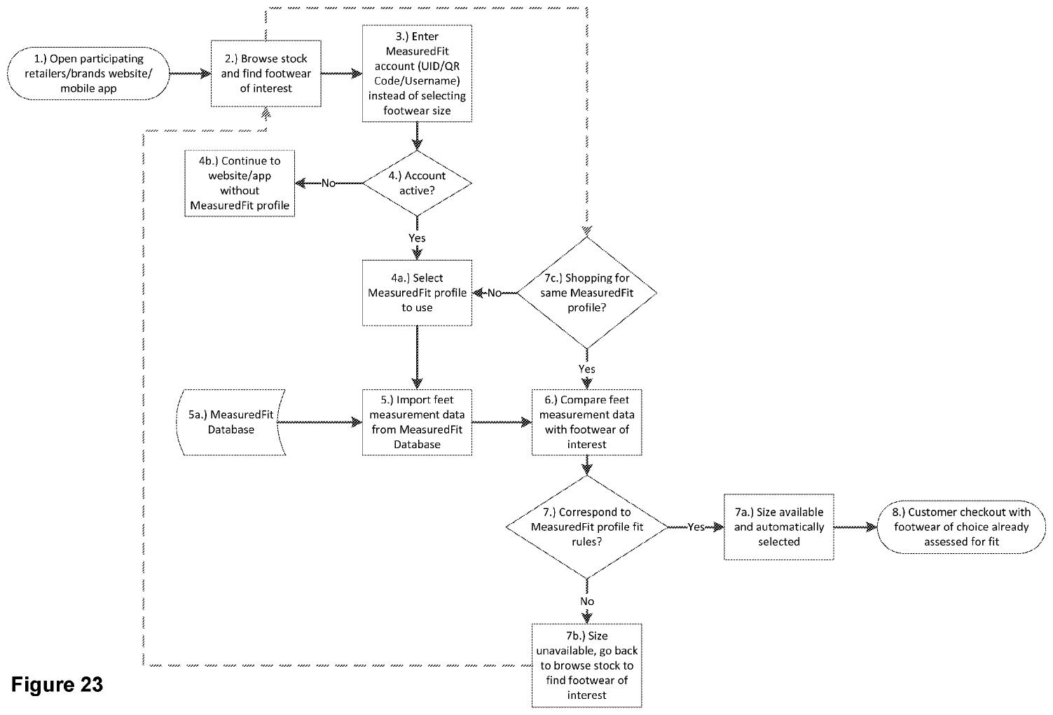

Reference is now made to FIG. 23, which sets out a new method for selecting footwear on a website/app, based on data stored by the MeasuredFit webservice rather than based on ‘traditional’ size information. For instance, if the potential footwear purchaser were otherwise relying on a ‘traditional sizing’ system, e.g. a UK men's size 7E, a shoe for one brand in size 7E may in fact have different dimensions to another brand selling a shoe having the ‘same’ size 7E. Use of the system, as set out below, ameliorates such problems, by integrating the webservice with a retailer's website/app to ensure purchasers are only able to purchase footwear which fits according to measurement data taken by device 100.

In step 1, a potential purchaser of footwear (referred to hereinafter as a user) navigates to a footwear retailer's website (or accesses an app provisioned by that retailer, etc.). The user browses the footwear options available to them to find footwear of interest (step 2).

In step 3, instead of the user selecting a ‘traditional’ footwear size, in this example the retailer's website/app is instead configured to retrieve the user's measurement data stored in the system. In this regard, in step 4, a determination is made as to whether or not the user has a valid and active MeasuredFit account (e.g. by attempting to login). If not, then the process ends at step 4b with the user proceeding to use the website without the benefit of the MeasuredFit functionality, else the procedure continues in step 4a, and the user is able to select a MeasuredFit profile to use.

Once a profile has been selected, in step 5, the retailer's website/app imports the measurement data stored against the user's profile from the system's database.

Subsequently, in step 6, the retailer's website compares the user's measurement data to the footwear of interest found in step 2, and then, in step 7, a determination is made as to whether the retailer has stock of the footwear of interest in a size suitable to fit the user based on the provided measurement data, and, if so, this size is automatically selected (step 7a). If the user's size is unavailable, then the process returns to step 2, enabling the user to choose different footwear of interest if they wish, and also to indicate (in step 7c) whether they still wish to use their MeasuredFit profile or to select that of another person such as a family member to potentially buy the footwear for. The procedure then proceeds from step 6 (or if the user wishes to use an alternative profile, then the procedure proceeds from step 4a). Accordingly, in step 8, the user may purchase footwear of an appropriate size based on the selected profile.

### In-Store Integration

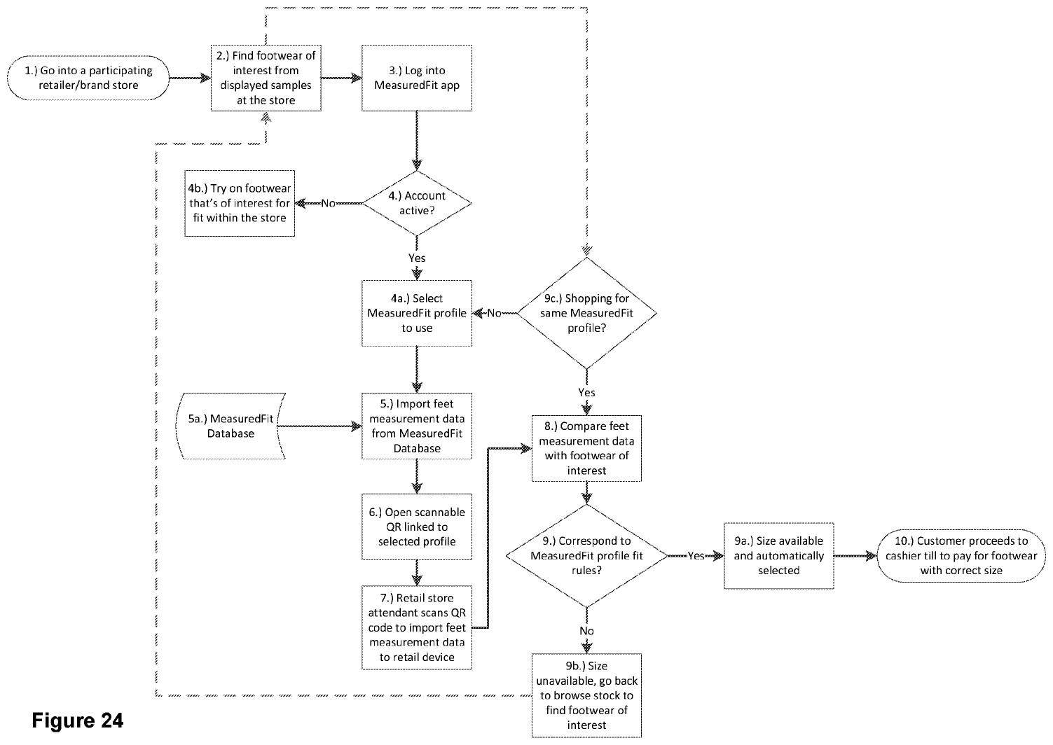

Reference is now made to FIG. 24, which sets out a process for using the mobile application and associated MeasuredFit system in physical retail stores.

In step 1, a potential purchaser (referred to herein after as a user) goes to a physical footwear retailer, and browses the available footwear options to find footwear of interest (step 2).

In step 3, the user accesses the mobile application and logs in to their MeasuredFit account. A determination is then made as to whether or not the user has a valid and active MeasuredFit account (step 4). If not, then the process ends at step 4b with the user proceeding to shop in the store without the benefit of the MeasuredFit system, else the procedure continues in step 4a, and the user selects a MeasuredFit profile to use.

Once a profile has been selected, in step 5 the mobile application imports the measurement data stored against the user's chosen profile from the MeasuredFit system's database.

In step 6, the app generates a scannable code (e.g. a QR code), which is linked to the user's selected profile, and which is scanned in step 7 by one of the retailer's attendants using an appropriate retailer device (such as the camera of a smartphone or tablet), thereby importing the user's measurement data into the retailer's device for processing in the retailer's system. Alternatively, instead of generating a visual code, in steps 6 and 7 the user's measurement data may be transmitted from the user's app to the retailer's system by wireless means, e.g. via the internet or using NFC (near field communication) between the devices.

In step 8, the retailer's device compares the measurement data of the selected profile to the footwear of interest found in step 2, then, in step 9, a determination is made by the retailer's device as to whether the retailer has stock of the footwear of interest in a size suitable to fit the user based on the provided measurement data. If stock is available in the desired size, this size is automatically selected (step 9a). If the desired size is unavailable, then the process returns to step 2, enabling the user to choose different footwear of interest if they wish, and also to indicate (in step 9c) whether they still wish to use their MeasuredFit profile or to select that of another person such as a family member to potentially buy the footwear for. The procedure then proceeds from step 8 (or if the user wishes to use an alternative profile, then the procedure proceeds from step 4a). Accordingly, in step 10 the user may purchase footwear of an appropriate size based on the selected profile.

Beneficially, therefore, the system when integrated with a retailer's physical store as set out above means users do not need to remember their size information (such a UK men's 11E, which could be particularly problematic to remember if buying footwear for e.g. a family member) and further ensures that a user is only able to be presented with and purchase footwear having dimensions which match the measurements associated with the selected profile, thereby ensuring that the purchased footwear fits precisely.

### Modifications and Alternatives

Detailed embodiments and some possible alternatives have been described above. As those skilled in the art will appreciate, a number of modifications and further alternatives can be made to the above embodiments whilst still benefiting from the inventions embodied therein.

With the above-described measuring device (e.g. as shown in FIG. 1), four members 10, 20, 30 and 40 are provided, to enable substantially simultaneous measurement of the length and width (or girth) of the foot, and also to locate the device around the foot in a reliable and repeatable manner. However, alternative variants of the device may only have two members, for example the first and second members 10, 20 as described above. Thus, in a simpler form, the device may comprise only first and second members 10, 20 for abutting against opposing portions of the foot, and an extendable measuring tape 12 bearing measuring indicia as described above, wherein one of the members comprises a window through which a portion of the measurement indicia, representative of the extent of extension of the measuring tape, is visible in use. In use, such a simplified device would not be limited to measuring the distance between the toes and the heel of the foot, but could also be used perpendicular to the longest axis of the foot, for instance by placing the first member 10 in contact with the widest part of the foot and placing the second member 20 on the opposing side of the foot. Thus, by using the simplified device first in the heel-to-toe orientation and obtaining a measurement, and then rotating it into the side-to-side orientation and obtaining a respective measurement, the user can obtain the width measurement of the foot, as well as the length of the foot.

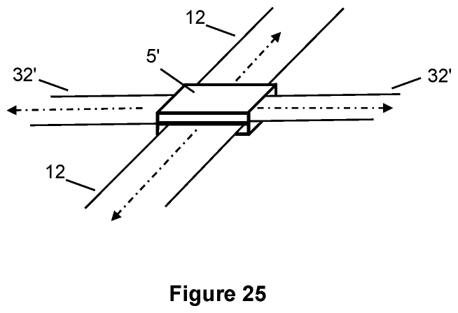

With the above-described measuring device (e.g. as shown in FIG. 1), the third member 30 has a second measuring tape 32, and the fourth member 40 has a third measuring tape 42, wherein the distal end of the third measuring tape 42 is coupled to the distal end of the second measuring tape 32 by means of a sleeve 5 through which the first measuring tape 12 slidably passes. However, in alternative variants of the device, a single second measuring tape may be provided, directly connecting the third and fourth members 30, 40, instead of separate second and third tapes. This single second measuring tape is denoted by 32′ in FIG. 25, which also shows a modified sleeve 5′ but otherwise the overall configuration of the measuring device may be as shown in FIG. 1. Thus, such a variant may comprise a second measuring tape 32′, wherein a proximal end of the second measuring tape 32′ is coupled to the third member 30 and a distal end of the second measuring tape 32′ is coupled to the fourth member 40, the second measuring tape 32′ being extendable from and retractable into the third member 30; wherein the second measuring tape 32′ comprises measurement indicia along at least part of the length of the tape; and wherein the third member 30 comprises a window through which a portion of the measurement indicia, representative of the extent of extension of the second measuring tape 32′ from the third member, is visible in use. It will be appreciated that, in such case, the fourth member 40 need not incorporate a measurement window (i.e. in a similar manner to the second member 20 described above). With such a variant, the first measuring tape 12 crosses the second measuring tape 32′. To enable the first and second measuring tapes 12, 32′ to cross and slide relative to one another, a sleeve component 5′ as shown in FIG. 25 may be employed, having an upper sleeve and a lower sleeve at right angles to each another. This enables the first measuring tape 12 to slide through the lower sleeve (say), independently of the second measuring tape 32′ sliding orthogonally through the upper sleeve, whilst also constraining the first and second tapes 12, 32′ (and their respective members 10 and 20; and 30 and 40) in an orthogonal configuration. Accordingly, members 30, 40 can be adjusted independently of members 10, 20, as illustrated by the dashed arrows.

Finally, with the encoding methodology for the continuous two-dimensional barcode described above (with reference to FIG. 16), it was explained that the order of the bits of the measurement bit string may be reversed, depending on whether the respective measurement value is odd or even (e.g. as denoted by the first and second indicator bits). However, instead of (or in addition to) reversing the order of those bits in the manner as discussed above, the colours (e.g. black and white) of the bits of the measurement bit string may also be reversed (in effect, changing ‘0’s to ‘1’s, and ‘1’s to ‘0’s), depending on whether the respective measurement value is odd or even.

1. A device for measuring a human foot, the device comprising:
a first member for abutting against a first portion of the foot;
a second member for abutting against a second portion of the foot, the second member opposing the first member; and
a measuring tape, wherein a proximal end of the measuring tape is coupled to the first member and a distal end of the measuring tape is coupled to the second member, the measuring tape being extendable from and retractable into the first member;
wherein the measuring tape comprises measurement indicia along at least part of the length of the tape; and
wherein the first member comprises a window through which a portion of the measurement indicia, representative of the extent of extension of the measuring tape from the first member, is visible in use.

2. The device according to claim 1, wherein the first member further comprises a spring-biased spool, onto which the measuring tape is retractable, and from which the measuring tape is extendable;
optionally wherein the first member further comprises an internal guide structure, by means of which the measuring tape from the spool is arranged to pass across the window, within the first member, before coming out of the first member.

3. (canceled)

4. The device according to claim 1, wherein the measuring tape is a first measuring tape, and the device further comprises:
a third member for abutting against a third portion of the foot;
a fourth member for abutting against a fourth portion of the foot, the fourth member opposing the third member;
a second measuring tape, wherein a proximal end of the second measuring tape is coupled to the third member and a distal end of the second measuring tape is extendable away from the third member, the second measuring tape being extendable from and retractable into the third member; and
a third measuring tape, wherein a proximal end of the third measuring tape is coupled to the fourth member and a distal end of the third measuring tape is extendable away from the fourth member, the third measuring tape being extendable from and retractable into the fourth member;
wherein the distal end of the third measuring tape is coupled to the distal end of the second measuring tape;
wherein each of the second and third measuring tapes comprises measurement indicia along at least part of the length of the respective tape; and
wherein the third member comprises a second window and the fourth member comprises a third window through which a respective portion of the measurement indicia of the respective second and third measuring tapes, representative of the extent of extension of the second and third measuring tapes, are visible in use;
optionally wherein the distal end of the third measuring tape is coupled to the distal end of the second measuring tape by means of a sleeve through which the first measuring tape slidably passes.

5. (canceled)

6. The device according to claim 4, wherein each of the third and fourth members further comprises a respective spring-biased spool, onto which the respective measuring tape is retractable, and from which the respective measuring tape is extendable;
optionally wherein each of the third and fourth members further comprises a respective internal guide structure, by means of which the respective measuring tape from the respective spool is arranged to pass across the respective window, within the respective member, before coming out of the respective member.

7. (canceled)

8. The device according to claim 1, wherein the measuring tape is a first measuring tape, and the device further comprises:
a third member for abutting against a third portion of the foot;
a fourth member for abutting against a fourth portion of the foot, the fourth member opposing the third member; and
a second measuring tape, wherein a proximal end of the second measuring tape is coupled to the third member and a distal end of the second measuring tape is coupled to the fourth member, the second measuring tape being extendable from and retractable into the third member;
wherein the second measuring tape comprises measurement indicia along at least part of the length of the tape; and
wherein the third member comprises a window through which a portion of the measurement indicia, representative of the extent of extension of the second measuring tape from the third member, is visible in use.

9. The device according to claim 4, wherein the third and fourth members are generally perpendicular to an axis of the first measuring tape, and are mutually movable along the axis of the first measuring tape.

10. The device according to claim 4, wherein the third member and the fourth member are mutually couplable to one another at a fifth portion of the foot, for measuring the girth of the foot;
optionally wherein the third member and the fourth member each comprise magnets for mutual coupling between the third and fourth members;
optionally wherein the first member and the second member comprise magnets for respectively coupling to the third member and the fourth member.

11.-12. (canceled)

13. The device according to claim 1, wherein at least one of the members comprises a lanyard or handle.

14. The device according to claim 1, wherein at least one window is provided with an identifying marker around or adjacent to at least part of the window, by means of which the window can be uniquely identified.

15. The device according to claim 1, wherein the members are configured to tessellate into a closed configuration when the respective measuring tapes are fully retracted.

16. The device according to claim 1, wherein the first member and/or the second member further comprises an inwardly-extending base part on which the user places a respective portion of their foot in use.

17. The device according to claim 4, wherein the first member and/or the second member further comprises an inwardly-extending base part on which the user places a respective portion of their foot in use, wherein the or each inwardly-extending base part is arranged to align and support the third and fourth members when the respective measuring tapes are fully retracted and the device is in the a closed configuration.

18. The device according to claim 1, wherein the second member further comprises a further measuring strap;
optionally wherein the members are configured to tessellate into a closed configuration when the respective measuring tapes are fully retracted, and wherein the further measuring strap is usable to wrap around the members to secure the device in the closed configuration.

19. (canceled)

20. The device according to claim 1, wherein the measurement indicia comprises a two-dimensional barcode extending in a first direction along at least part of the length of the respective measuring tape, and in a second direction across at least part of the width of the measuring tape;
wherein the two-dimensional barcode comprises a plurality of successive rows of pixels neighbouring each other in the first direction; and
wherein each row of pixels extends in the second direction and uniquely encodes a respective measurement value;
optionally wherein the width of the respective window, through which said portion of the measurement indica is visible in use, corresponds to the length of the row of pixels across the measuring tape;
optionally wherein the successive rows of pixels are immediately adjacent to one another.

21. The device according to claim 20, wherein each row of pixels comprises the respective measurement value encoded into a binary measurement bit string, wherein, in each measurement bit string, pixels of a first colour denote bits of ‘1’, and pixels of a second colour denote bits of ‘0’;
optionally wherein the measurement bit string comprises nine binary digits;
optionally wherein, in addition to the measurement bit string, each row of pixels further comprises an orientation bit to indicate the orientation of the row of pixels.

22.-23. (canceled)

24. The device according to claim 21, wherein, in addition to the measurement bit string, each row of pixels further comprises one or more indicator bits to indicate whether the respective measurement value is odd or even;
optionally wherein each row of pixels comprises a first indicator bit to indicate whether the respective measurement value is even, and a second indicator bit to indicate whether the respective measurement value is odd;
optionally wherein each row of pixels comprises, in order, the orientation bit, the first indicator bit, the measurement bit string, and the second indicator bit.

25.-26. (canceled)

27. The device according to claim 24, wherein the order of the bits of the measurement bit string is reversed depending on whether the respective measurement value is odd or even; and/or
wherein the colours of the bits of the measurement bit string are reversed depending on whether the respective measurement value is odd or even.

28.-30. (canceled)

31. A method for measuring a foot using the device according to claim 1, the method comprising:
abutting the members of the device against respective portions of the foot, and in so doing,
extending the respective measuring tape(s) to cause respective portion(s) of the measurement indicia, representative of the extent of extension of the measuring tape(s), to become visible in the respective window(s);
optionally wherein the method further comprises:
imaging, using a camera of a user device, the measurement indicia visible through the window(s); and
processing the imaged measurement indicia to determine corresponding measurement value(s).

32. (canceled)

33. The method according to claim 31, further comprising:
comparing prestored measurement data of a plurality of items of footwear to the obtained measurement value(s);
determining the suitability of fit of available footwear relative to the obtained measurement value(s) based on the comparison; and
displaying only footwear which are suitable based on the determination;
or wherein the method further comprises:
receiving, from a user, a selection of an item of footwear, without reference to the size of the item of said footwear;
comparing prestored measurement data of one or more available items of said footwear to the obtained measurement value(s);
determining the availability of a suitability-fitting item of said footwear relative to the obtained measurement value(s) based on the comparison; and
providing the suitable footwear based on the determination;
or wherein the method further comprises:
generating a code representative of the obtained measurement value(s);
providing the generated code to a retailer device;
comparing prestored measurement data of one or more available items of footwear to the measurement value(s) obtained via the code;
determining the availability of a suitability-fitting item of footwear relative to the obtained measurement value(s) based on the comparison; and
providing the suitable footwear based on the determination.

34.-35. (canceled)

36. A computer program for causing a user device and/or a server to execute the method of claim 31.
